(19) United States
(12) Patent Application Publication
(10) Pub. No.: US 2026/0001974 A1
(43) Pub. Date: Jan. 1, 2026

(54) DISULFUR DICHLORIDE AND SILANE/SILOXANE ADDITIVE FOR MOONEY JUMP

(71) Applicant: The Goodyear Tire & Rubber Company, Akron, OH (US)

(72) Inventors: Milad Mesgar, Beachwood, OH (US); Aaron Patrick Murray, Chardon, OH (US); Margaret Flook Vielhaber, Kent, OH (US)

(21) Appl. No.: 18/793,417

(22) Filed: Aug. 2, 2024

Related U.S. Application Data
(60) Provisional application No. 63/664,297, filed on Jun. 26, 2024.

(51) Int. Cl. C08F 136/06; B60C 1/00

(52) U.S. Cl. CPC C08F 136/06; B60C 1/0016; B60C 1/0041

(57) ABSTRACT

A method for the synthesis of an elastomer comprising the steps of polymerizing conjugated diene monomer in to generate a polydiene cement; terminating the polydiene cement with a protic organic compound; connecting polymer chains by reacting (1) a compound containing sulfur and a halogen with (2) a silane or siloxane; and adding a product of the reaction to the cement to generate a polydiene rubber.

### BACKGROUND OF THE INVENTION

The use of polybutadiene, polyisoprenes, polystyrenes, and their copolymers is known in rubber and tire industries. When cured, high 1,4-cis content polybutadienes impart unique performance properties on downstream products. 1,4-cis polydienes formed by lanthanide-based (aka rare earth) catalyst systems contain a linear backbone and are believed to provide better tensile properties, higher abrasion resistance, lower hysteresis, and better fatigue resistance compared to the 1,4-cis polydienes prepared with other catalyst systems.

Nowadays, and almost exclusively, high 1,4-cis content polybutadienes are produced using rare earth transition metal catalysts, such as neodymium. Despite the advantages, using such catalysts in production of high 1,4-cis content polybutadienes presents certain challenges: high solution viscosity; low solids production rates; fouling; and high cold flow; etc. Nearly all high 1,4-cis polydiene production facilities face these challenges due to an increased industrial demand of this rubber.

Efforts have been made to improve these challenges. For example, U.S. Pat. No. 10,316,121 discloses certain Lewis acid additives to the polymerization systems, including the active cement for preparing high 1,4-cis polydienes having useful resistance to cold flow via a lanthanide-based catalyst and a conjugated diene monomer.

U.S. Pat. No. 6,576,731 discloses certain reagents to reduce solution viscosity/Mooney viscosity ratio in the preparation of polybutadienes via lanthanide-based catalysts. The reagents are specific silanes used as an intermediate product for the preparation of the polybutadienes.

U.S. Pat. No. 9,845,366 and WO2023193943 use the disulfur dichloride (aka sulfur monochloride), sulfur dichloride and/or thionyl chloride as a Mooney jump additive for high-molecular-weight polybutadiene having >95% by weight content of 1,4-cis units and <1% by weight 1,2-vinyl content.

The reactivity of disulfur dichloride toward the neodymium cement with high-molecular-weight polybutadiene—characterized by high 1,4-cis units and low 1,2-vinyl content (and hereinafter referred to as high MW polybutadiene) is high. When adding it directly to the cement, it will generate an undesired and very high molecular weight species. In other words, the direct addition of disulfur dichloride to the cement will cause immediate local gelation.

It is now discovered that reactivity of disulfur dichloride diminishes when reacted with vinyl silane and vinyl siloxane prior to addition to neodymium cement. And upon further addition to the neodymium cement, it will give a different degree of the cement Mooney jump. The disclosed process provides a functionalized rubber as well as improved processability. The present disclosure further relates to the processes during which the polydiene compositions are synthesized.

### SUMMARY OF THE INVENTION

The present invention provides a functionalized polydiene with improved processability while maintaining and/or enhancing the performance of a downstream product incorporating such polydiene. The improved processability and performance is achieved by adding disulfur dichloride solution and silane/siloxane adduct by means of a Mooney jump additive (hereinafter defined and referred to as a “TAXI”).

One or more embodiments of this disclosure relates to a method of preparing a functionalized cis polydiene with increased Mooney jump. According to the contemplated methods, a polymerization system of 1,4-cis polydiene is prepared by introducing a lanthanide-based catalyst and a conjugated diene monomer compound, which will be exposed to a TAXI after a termination step to show Mooney jump. A critical aspect of the invention is to promote the Mooney jump after termination of the cement.

Other embodiments of this disclosure relate to a method of preparing a functionalized polydiene with increased Mooney jump. According to the contemplated methods, an anionic polymerization system of polydiene is prepared by introducing a butyl lithium, a modifier, and a conjugated diene monomer compound which will be exposed to a TAXI to show Mooney jump.

Other embodiments of this disclosure relate to a method of preparing a functionalized styrene-butadiene polymer with increased Mooney jump. According to the contemplated methods, an anionic polymerization system of styrene-butadiene is prepared by introducing a butyl lithium, a modifier, styrene, and a conjugated diene monomer compound which will be exposed to a TAXI to show Mooney jump.

As mentioned supra, a TAXI will comprise three components: A) disulfur dichloride (S₂Cl₂) or any of its families, such as, for example SCl₂, SOCl₂, S₂Br₂, SOBr₂ or a combination thereof; B) silane or siloxane compounds or a combination thereof; and C) organic solvents.

The present disclosure also relates to silane compounds defined by the formula I:

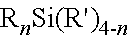

wherein n=1 to 4 and R can be hydrogen, aliphatic hydrocarbon, cycloaliphatic hydrocarbon, aromatic hydrocarbon, cycloaliphatic, a monovalent organic group or a combination(s) thereof. The R′ can be vinyl, allyl, butenyl, pentenyl, hexenyl, or generally any alkenyl functionalities or organic functionalities bearing unsaturated carbon-carbon bonds.

The present disclosure also relates to silane compounds defined by the formula II:

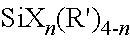

Wherein n=1 to 4 and X can be (OR), (SR), (SeR), (NR₂), (PR₂), halogens, acrylates, heterocycles, a monovalent organic group or a combination(s) thereof. The R′ can be vinyl, allyl, butenyl, pentenyl, or generally any alkenyl functionalities or organic functionalities bearing unsaturated carbon-carbon bonds.

The present disclosure also relates to siloxane compounds defined by the formula III:

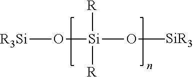

Where n=0 to 16 and R is either methyl or vinyl, allyl, butenyl, pentenyl, hexenyl, or generally any alkenyl functionalities or organic functionalities bearing unsaturated carbon-carbon bonds.

The present disclosure also relates to cyclic siloxane compounds defined by the formula IV:

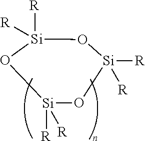

Where n=1 to 5 and R is either methyl or vinyl, allyl, butenyl, pentenyl, hexenyl, or generally any alkenyl functionalities or organic functionalities bearing unsaturated carbon-carbon bonds.

The solvent used in the disclosed TAXIs formulation comprises polar and non-polar organic solvents such as dodecane, dodecanol, 1,2-expoxydodecane, or dodecanoic acid.

### DETAILED DESCRIPTION OF THE INVENTION

It is now discovered that addition of TAXIs to a 1,4-cis polydiene cement is the basis, at least in part, of producing a 1,4-cis polydiene with higher Mooney viscosity compared to a control sample without any TAXIs. Another aspect of this invention is a 1,4-cis polydiene produced using such TAXI and that has functionalities, which later selectively may or may not increase the performance of the downstream product. The contemplated TAXIs comprise a mixture of sulfur and a halogen, such as disulfur dichloride (S₂Cl₂) or any of its families, e.g., SCl₂, SOCl₂, S₂Br₂, SOBr₂ or a combination thereof, and a silane or siloxane, and organic solvents. Incorporation of the disclosed TAXIs promotes either a long-chain branching of the 1,4-cis polydiene or cross-linked polydienes. Additionally, they desirably reduce the number of process steps, minimize by-product waste, and increase the efficiency of the process. Such TAXIs should be prepared without any special or specific system design that is out of the normal practice of chemical industries.

One or more embodiments of this disclosure provide a method of preparing a branched 1,4-cis polydiene using a lanthanide-based catalyst in which the final 1,4-cis polydiene shows significant cold flow improvement in addition to a Mooney jump.

According to embodiments of this disclosure, a method comprises the steps of preparing the branched or cross-linked polymers by connecting the two polymer chains with the TAXIs, wherein the reactor system is batched or continuous or a mix of two.

### I. Diene Monomer

The 1,4-cis polydienes may be prepared by polymerizing conjugated diene monomer using the disclosed catalyst system. Many types of unsaturated monomers, which contain carbon-carbon double bonds, can be polymerized into polymers using such metal catalysts. Elastomeric or rubbery polymers can be synthesized by polymerizing diene monomers utilizing this type of metal initiator system. The diene monomers that can be polymerized into synthetic rubbery polymers can be either conjugated or nonconjugated diolefins. Conjugated diolefin monomers containing from 4 to 8 carbon atoms are generally preferred. Vinyl-substituted aromatic monomers can also be copolymerized with one or more diene monomers into rubbery polymers, such as, for example styrene-butadiene rubber (SBR). Some representative examples of conjugated diene monomers that can be polymerized into rubbery polymers include 1,3-butadiene, isoprene, 1,3-pentadiene, 2,3-dimethyl-1,3-butadiene, 2-methyl-1,3-pentadiene, 2,3-dimethyl-1,3-pentadiene, 2-phenyl-1,3-butadiene, and 4,5-diethyl-1,3-octadiene. Some representative examples of vinyl-substituted aromatic monomers that can be utilized in the synthesis of rubbery polymers include styrene, 1-vinylnapthalene, 3-methylstyrene, 3,5-diethylstyrene, 4-propylstyrene, 2,4,6-trimethylstyrene, 4-dodecylstyrene, 3-methyl-5-normal-hexylstyrene, 4-phenylstyrene, 2-ethyl-4-benzylstyrene, 3,5-diphenylstyrene, 2,3,4,5-tetraethylstyrene, 3-ethyl-1-vinylnapthalene, 6-isopropyl-1-vinylnapthalene, 6-cyclohexyl-1-vinylnapthalene, 7-dodecyl-2-vinylnapthalene, α-methylstyrene, and the like.

There is no limitation made herein to the diene monomers employed. In one embodiment the monomer can be 1,3-butadiene, which can be polymerized and produce cis-1,4 polybutadiene. In one embodiment the monomer can be isoprene, which can be polymerized and produce cis-1,4 polybutadiene.

### II. The Catalyst System

The invention disclosed here is not necessarily limited by specific lanthanide-based systems. In embodiments of the disclosure, the catalyst systems used in the process of this invention is made by preforming three catalyst components: (1) an alkylating agent; (2) a lanthanide-containing compound; and (3) a halogen source. In other embodiments, a compound containing a non-coordinating anion can be employed as a halogen source. In solution polymerizations of this invention, a polymerization medium comprising (4) an organic solvent may also be used.

Preferred catalyst components comprise (1) an organoaluminum compound, (2) a neodymium carboxylate or organophosphate or phosphinate or phosphonates, and (3) a dialkyl aluminum chloride. In making the neodymium catalyst system, the neodymium carboxylate and the organoaluminum compound are first reacted together for 10 minutes to 30 minutes in the presence of isoprene to produce a neodymium-aluminum catalyst component. The neodymium carboxylate and the organoaluminum compound are preferably reacted for 12 minutes to 30 minutes and are more preferably reacted for 15 to 25 minutes in producing the neodymium-aluminum catalyst component.

Suitable neodymium carboxylates include, but are not limited to, neodymium neodecanoate (a.k.a., neodymium versatate), neodymium 2-ethylhexanoate, neodymium oleate, neodymium stearate, neodymium formate, neodymium acetate, neodymium valerate, neodymium oxalate, neodymium naphthenate, neodymium gluconate, neodymium citrate, neodymium lactate, neodymium maleate, neodymium benzoate, and neodymium picolinate.

Suitable neodymium organophosphates include, but are not limited to, neodymium didodecyl phosphate, neodymium didecyl phosphate, neodymium dioctadecyl phosphate, neodymium dioleyl phosphate, neodymium dioctyl phosphate, neodymium diheptyl phosphate, neodymium dihexyl phosphate, neodymium dipentyl phosphate, neodymium dibutyl phosphate, neodymium bis(1-methylheptyl)phosphate, neodymium bis(2-ethylhexyl)phosphate, neodymium diphenyl phosphate, neodymium butyl(2-ethylhexyl)phosphate, and neodymium(1-methylheptyl)(2-ethylhexyl)phosphate.

Suitable neodymium organophosphinates include, but are not limited to, neodymium didodecylphosphinate, neodymium didecylphosphinate, neodymium dodecylphosphinate, neodymium decylphosphinate, neodymium dioctadecylphosphinate, neodymium dioctylphosphinate, neodymium octylphosphinate, neodymium octadecylphosphinate, neodymium heptylphosphinate, neodymium diheptylphosphinate, neodymium hexylphosphinate, neodymium dihexylphosphinate, neodymium pentylphosphinate, neodymium dipentylphosphinate, neodymium butylphosphinate, neodymium dibutylphosphinate, neodymium(1-methylheptyl)phosphinate, neodymium(2-ethylhexyl)phosphinate, neodymium oleylphosphinate, neodymium phenylphosphinate, neodymium(p-nonylphenyl)phosphinate, neodymium bis(1-methylheptyl)phosphinate, neodymium bis(2-ethylhexyl)phosphinate, neodymium dioleylphosphinate, neodymium diphenylphosphinate, and neodymium butyl(2-ethylhexyl)phosphinate.

Suitable neodymium organophosphonates include, but are not limited to, neodymium decyl phosphonate, neodymium dodecyl phosphonate, neodymium octadecyl phosphonate, neodymium octyl phosphonate, neodymium heptyl phosphonate, neodymium hexyl phosphonate, neodymium pentyl phosphonate, neodymium butyl phosphonate, neodymium octadecyl octadecylphosphonate, neodymium dodecyl dodecylphosphonate, neodymium decyl decylphosphonate, neodymium octyl octylphosphonate, neodymium heptyl heptylphosphonate, neodymium hexyl hexylphosphonate, neodymium pentyl pentylphosphonate, neodymium butyl butylphosphonate, neodymium(2-ethylhexyl)phosphonate, neodymium(2-ethylhexyl)(2-ethylhexyl)phosphonate, neodymium oleyl phosphonate, neodymium phenyl phosphonate, neodymium oleyl oleylphosphonate, neodymium phenyl phenylphosphonate, neodymium butyl(2-ethylhexyl)phosphonate, and neodymium(2-ethylhexyl)butylphosphonate.

The neodymium-aluminum catalyst component is then reacted with the dialkyl aluminum chloride for a period of at least 30 minutes to produce the neodymium catalyst system. The activity of the neodymium catalyst system normally improves as the time allowed for this step is increased up to about 24 hours. Greater catalyst activity is not normally attained by increasing the aging time over 24 hours. However, the catalyst system can be aged for much longer time periods before being used without any detrimental results.

The neodymium catalyst system will typically be performed at a temperature that is within the range of about 0° C. to about 100° C. The neodymium catalyst system will more typically be prepared at a temperature that is within the range of about 10° C. to about 60° C. The neodymium catalyst system will preferably be prepared at a temperature that is within the range of about 15° C. to about 30° C.

The organoaluminum compound contains at least one carbon to aluminum bond and can be represented by the structural formula:

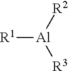

in which R¹ is selected from the group consisting of alkyl (including cycloalkyl), alkoxy, aryl, alkaryl, arylalkyl radicals and hydrogen: R² is selected from the group consisting of alkyl (including cycloalkyl), aryl, alkaryl, arylalkyl radicals and hydrogen and R³ is selected from a group consisting of alkyl (including cycloalkyl), aryl, alkaryl and arylalkyl radicals. Representative of the compounds corresponding to this definition are: diethylaluminum hydride, di-n-propylaluminum hydride, di-n-butylaluminum hydride, diisobutylaluminum hydride, diphenylaluminum hydride, di-p-tolylaluminum hydride, dibenzylaluminum hydride, phenylethylaluminum hydride, phenyl-n-propylaluminum hydride, p-tolylethylaluminum hydride, p-tolyl-n-propylaluminum hydride, p-tolylisopropylaluminum hydride, benzylethylaluminum hydride, benzyl-n-propylaluminum hydride, and benzylisopropylaluminum hydride and other organoaluminum hydrides. Also includes are ethylaluminum dihydride, butylaluminum dihydride, isobutylaluminum dihydride, octylaluminum dihydride, amylaluminum dihydride, and other organoaluminum dihydrides. Also included are diethylaluminum ethoxide and dipropylaluminum ethoxide. Also includes are trimethylaluminum, triethylaluminum, tri-n-propylaluminum, triisopropylaluminum, tri-n-propylaluminum, triisopropylaluminim, tri-n-butylaluminum, triisobutylaluminum, tripentylaluminum, trihexylaluminum, tricyclohexylaluminum, trioctylaluminum, triphenylaluminum, tri-p-tolylaluminum, tribenzylaluminum, ethyldiphenylaluminum, ethyl-di-p-tolylaluminum, ethyldibenzylaluminum, diethylphenylaluminum, diethyl-p-tolylaluminum, and diethylbenzylaluminum and other triorganoaluminum compounds.

The neodymium carboxylate utilizes an organic monocarboxylic acid ligand that contains from 1 to 20 carbon atoms, such as acetic acid, propionic acid, valeric acid, hexanoic acid, 2-ethylhexanoic acid, neodecanoic acid, lauric acid, stearic acid and the like, neodymium naphthenate, neodymium neodecanoate, neodymium octanoate, and other neodymium metal complexes with carboxylic acid containing ligands containing from 1 to 20 carbon atoms. Suitable neodymium carboxylates include, but are not limited to, neodymium neodecanoate (a.k.a., neodymium versatate), neodymium 2-ethylhexanoate, neodymium oleate, neodymium stearate, neodymium formate, neodymium acetate, neodymium valerate, neodymium oxalate, neodymium naphthenate, neodymium gluconate, neodymium citrate, neodymium lactate, neodymium maleate, neodymium benzoate, and neodymium picolinate.

The proportions of the catalyst components utilized in making the neodymium catalyst system of this invention can be varied widely. The atomic ratio of the halide ion to the neodymium metal can vary from about 0.1/1 to about 6/1. A more preferred ratio is from about 0.5/1 to about 3.5/1 and the most preferred ratio is about 2/1. The molar ratio of the trialkylaluminum or alkylaluminum hydride to neodymium metal can range from about 4/1 to about 200/1 with the most preferred range being from about 8/1 to about 100/1. The molar ratio of isoprene to neodymium metal can range from about 0.2/1 to 3000/1 with the most preferred range being from about 5/1 to about 500/1.

The amount of catalyst used to initiate the polymerization can be varied over a wide range. Low concentrations of the catalyst system are normally desirable in order to minimize ash problems. It has been found that polymerizations will occur when the catalyst level of the neodymium metal varies between 0.05 and 1.0 millimole of neodymium metal per 100 grams of monomer. A preferred ratio is between 0.1 and 0.3 millimole of neodymium metal per 100 grams of monomer.

The concentration of the total catalyst system employed of course, depends upon factors such as purity of the system, polymerization rate desired, temperature and other factors. Therefore, specific concentrations cannot be set forth except to say that catalytic amounts are used.

Temperatures at which the polymerization reaction is carried out can be varied over a wide range. Usually, the temperature can be varied from extremely low temperatures such as −60° C. up to high temperatures, such as 150° C. or higher. Thus, the temperature is not a critical factor of the invention. It is generally preferred, however, to conduct the reaction at a temperature in the range of from about 10° C. to about 90° C. The pressure at which the polymerization is carried out can also be varied over a wide range. The reaction can be conducted at atmospheric pressure or, if desired, it can be carried out at sub-atmospheric or super-atmospheric pressure. Generally, a satisfactory polymerization is obtained when the reaction is carried out at about autogenous pressure, developed by the reactants under the operating conditions used.

The polymerization can be terminated by the addition of an alcohol, acid, or another protic source, such as water. Such a termination step results in the formation of a protic acid. However, it has been unexpectedly found that better color can be attained by utilizing an alkaline aqueous neutralizer solution to terminate the polymerization. Another advantage of using an alkaline aqueous neutralizer solution to terminate the polymerization is that no residual organic materials are added to the polymeric product.

Polymerization can be terminated by simply adding an alkaline aqueous neutralizer solution to the polymer cement. The amount of alkaline aqueous neutralizer solution added will typically be within the range of about 1 weight percent to about 50 weight percent based upon the weight of the polymer cement. More typically, the amount of the alkaline aqueous neutralizer solution added will be within the range of about 4 weight percent to about 35 weight percent based upon the weight of the polymer cement. Preferably, the amount of the alkaline aqueous neutralizer solution added will be within the range of about 5 weight percent to about 15 weight percent based upon the weight of the polymer cement.

The alkaline aqueous neutralizer solution will typically have a pH which is within the range of 7.1 to 9.5. The alkaline aqueous neutralizer solution will more typically have a pH which is within the range of 7.5 to 9.0 and will preferably have a pH that is within the range of 8.0 to 8.5. The alkaline aqueous neutralizer solution will generally be a solution of an inorganic base, such as sodium carbonate, potassium carbonate, sodium bicarbonate, a potassium bicarbonate, a sodium phosphate, a potassium phosphate, and the like. For instance, the alkaline aqueous neutralizer solution can be a 0.25 weight percent solution of sodium bicarbonate in water. Since the alkaline aqueous neutralizer solution is not soluble with the polymer cement it is important to utilize a significant level of agitation to mix the alkaline aqueous neutralizer solution throughout the polymer cement to terminate the polymerization. Since the alkaline aqueous neutralizer solution is not soluble in the polymer cement, it will readily separate after agitation is discontinued.

The 1,4-cis polydiene of the present invention is made via solution polymerization in the presence of a neodymium catalyst system. Such polymerizations are typically conducted in a hydrocarbon solvent that can be one or more aliphatic, aromatic, paraffinic, or cycloparaffinic compounds. These solvents will normally contain from 4 to 10 carbon atoms per molecule and will be liquids under the conditions of the polymerization. Some representative examples of suitable organic solvents include pentane, isooctane, cyclohexane, normal hexane, benzene, toluene, xylene, ethylbenzene, and the like, alone or in a mixture.

Catalyst systems that may be employed in one or more embodiments of this invention are commercially available. For example, useful preformed catalyst systems are available under the tradename COMCAT Nd-FC (NH), COMCAT Nd-FC/20 (NH), and COMCAT Nd-FC/SF [COMAR CHEMICALS (Pty) Ltd].

### III. The TAXI

As used herein, a “TAXI” refers to a mixture that contains three components, the first component is disulfur dichloride (S₂Cl₂) or any of its families such as SCl₂, SOCl₂, S₂Br₂, SOBr₂ or a combination thereof. The second component is a silane or a siloxane compound or a combination thereof. The third component is an organic solvent.

For illustrative purposes only, disulfur dichloride (S₂Cl₂) will be used hereinafter as the representative of the first component but is no way limiting.

The phase of a TAXI can be liquid, gel, oil, and solid. In the case of solid, it will be mixed with more solvent to have a uniform liquid, gel, or oil.

In one or more embodiments, the ratio of the silane or siloxane to disulfur dichloride (S₂Cl₂) may be 1 to 1. In other embodiments the ratio of the silane or siloxane to disulfur dichloride (S₂Cl₂) may be 1 to 2. In other embodiments the ratio of the silane or siloxane to disulfur dichloride (S₂Cl₂) may be 1 to 3. In other embodiments the ratio of the silane or siloxane to disulfur dichloride (S₂Cl₂) may be 1 to 4.

In one or more embodiments, the molarity of the silane or siloxane in the TAXI may be in the range of 0.01 to 12 molar.

In one or more embodiments, the reaction of silane/siloxane and disulfur dichloride (S₂Cl₂) might not require any solvent.

In one or more embodiments, the TAXI may be prepared at temperature between zero and room temperature with or without agitation/stirring. In other embodiments, the TAXI may be prepared at temperature below 70° C. In other embodiments, the TAXI may be prepared at temperature between 70° C. and 120° C.

In one or more embodiments, the TAXI may added 30 minutes after termination of the neodymium cement comprising the conversion of at least 95%.

In one or more embodiments, the TAXI may added 15 minutes after termination of the neodymium cement comprising the conversion of at least 95%.

In one or more embodiments, the TAXI may be mixed with antioxidant and be added 30 minutes after termination of the neodymium cement comprising the conversion of at least 95%.

In one or more embodiments, the TAXI may be mixed with antioxidant and be added 15 minutes after termination of the neodymium cement comprising the conversion of at least 95%.

In one or more embodiments, the TAXI may be added in a different reactor than that in which the polymerization was terminated.

In one or more embodiments, the amount of TAXI refers to the amount of silane/siloxane that is being made of. Therefore, 0.1 mmol of TAXI will refer to 0.1 mmol of silane/siloxane.

In one or more embodiments, the amount of the TAXI used to prepare the branched and/or cross-linked polydienes of the present invention may be represented by the amount of the polymer present within the polymerization mixture. In one or more embodiments, the amount of the TAXI employed is at least 0.5 mmol, in one or more embodiments at least 1 mmol, in one or more embodiments at least 2 mmol, in one or more embodiments at least 4 mmol, in one or more embodiments at least 5 mmol, in one or more embodiments at least 6 mmol, in one or more embodiments at least 7.5 mmol per 100 g of 1,4-cis polydiene.

Representative examples of suitable mono, di, tris vinyl silane/siloxane to form a TAXI reacting with S₂Cl₂ are, but not limited to: tetravinylsilane, trivinylsilane, phenyltris(vinyl)silane, methyltris(vinyl)silane, ethyltris(vinyl)silane, isopropyltris(vinyl)silane, chlorotris(vinyl)silane, methoxytris(vinyl)silane, ethoxytris(vinyl)silane, phenoxytris(vinyl)silane, divinylsilane, phenylbis(vinyl)silane, diphenylbis(vinyl)silane, methyl(phenyl)bis(vinyl)silane, chloro(phenyl)bis(vinyl)silane, methylbis(vinyl)silane, dimethylbis(vinyl)silane, chloro(methyl)bis(vinyl)silane, diethylbis(vinyl)silane, dichlorobis(vinyl)silane, diphenoxybis(vinyl)silane, dimethoxybis(vinyl)silane, diethoxybis(vinyl)silane, dimethylbis(vinyloxy)silane, diethylbis(vinyloxy)sialne, tetravinylsilane, triallylsilane, triallyl(phenyl)silane, triallyl(methyl)silane, triallyl(chloro)silane, triallylmethoxysilane, triallyethoxysilane, diallysilane, diallyl(phenyl)silane, diallyl(phenyl)silane, diallylbis(phenyl)silane, diallyl(methyl)(phenyl)silane, diallyl(methyl)silane, diallylbis(methyl)silane, diallyl(chloro)(methyl)silane, diallylbis(chloro)silane, diallyldimethoxysilane, diallydiethoxysilane, bis(allyloxy)bis(phenyl)silane, bis(allyloxy)(methyl)(phenyl)silane, bis(allyloxy)bis(methyl)silane, bis(allyloxy)bis(ethyl)silane, tris(allyloxy)(methyl)silane, tetraallyl orthosilicate, [dimethyl(vinyl)siloxy]bis(methyl)(vinyl)silane, 1,1,3,3,5,5-hexamethyl-1,5-divinyltrisiloxane, 1,1,3,3,5,5,7,7-octamethyl-1,7-divinyltetrasiloxane, 1,1,3,5,5-pentamethyl-1,3,5-trivinyltrisiloxane, vinylmethylsiloxane homopolymer, methyl[methyl(vinyl)siloxy](vinyl)silane, 2,4,6,8-tetramethyl-2,4,6,8-tetravinyl-1,3,5,7,2,4,6,8-tetraoxatetrasilocane, 2,4,6,8-tetravinyl-1,3,5,7,2,4,6,8-tetraoxatetrasilocane, 2,4,6,8,10-pentamethyl-2,4,6,8,10-pentavinyl-1,3,5,7,9,2,4,6,8,10-pentaoxapentasilecane.

### Final Polymer

In one or more embodiments, the final polymers may have a 1,2-linkage content that is less than 1.5% where the percentages are based upon the number of diene mer units adopting the 1,2-linkage versus the total number of diene mer units. In one or more embodiments, these polymers may have a 1,2-linkage content that is from about 0.05% to about 1.5%. The cis-1,4-, 1,2-, and trans-1,4-linkage contents can be determined by infrared spectroscopy.

In one or more embodiments, the number average molecular weight (Mn) of the cis-1,4-polydiene polymers may be from about 25,000 to about 700,000, and more preferably from about 50,000 to about 350,000, and most preferably about 125,000 to about 250,000 as determined using size exclusion chromotography (SEC). In the contemplated embodiment, the 1,4-cis polydiene is characterized by a Mooney viscosity measurement (ML1+4 at 100° C.) from about 15 to about 150 and, most preferably from 40 to about 65.

In one embodiment, the polymer may be 1,4-cis polybutadiene rubber (BR). The BR may be conveniently characterized, for example, by having at least a 90 percent cis 1,4-content. In one embodiment, the polymer is functionalized. In another embodiment, the polymer is not.

The final polymer may be compounded into a rubber composition. The rubber composition may optionally include, in addition to the polymer, one or more rubbers or elastomers containing olefinic unsaturation. The phrases “rubber or elastomer containing olefinic unsaturation” or “diene based elastomer” are intended to include both natural rubber and its various raw and reclaim forms as well as various synthetic rubbers. In the description of this invention, the terms “rubber” and “elastomer” may be used interchangeably, unless otherwise prescribed. The terms “rubber composition”, “compounded rubber” and “rubber compound” are used interchangeably to refer to rubber which has been blended or mixed with various ingredients and materials and such terms are well known to those having skill in the rubber mixing or rubber compounding art. Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile (which polymerize with butadiene to form NBR), methacrylic acid and styrene, the latter compound polymerizing with butadiene to form SBR, as well as vinyl esters and various unsaturated aldehydes, ketones and ethers, e.g., acrolein, methyl isopropenyl ketone and vinylethyl ether. Specific examples of synthetic rubbers include neoprene (polychloroprene), polybutadiene (including cis-1,4-polybutadiene), polyisoprene (including cis-1,4-polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers. The preferred rubber or elastomers are polyisoprene (natural or synthetic), polybutadiene and SBR.

In one aspect the at least one additional rubber is preferably of at least two of diene-based rubbers. For example, a combination of two or more rubbers is preferred such as cis 1,4-polyisoprene rubber (natural or synthetic, although natural is preferred), 3,4-polyisoprene rubber, styrene/isoprene/butadiene rubber, emulsion and solution polymerization derived styrene/butadiene rubbers, 1,4-cis polybutadiene rubbers and emulsion polymerization prepared butadiene/acrylonitrile copolymers.

In one aspect of this invention, an emulsion polymerization derived styrene/butadiene (E-SBR) might be used having a relatively conventional styrene content of about 20 to about 28 percent bound styrene or, for some applications, an E-SBR having a medium to relatively high bound styrene content, namely, a bound styrene content of about 30 to about 45 percent.

By emulsion polymerization prepared E-SBR, it is meant that styrene and 1,3-butadiene are copolymerized as an aqueous emulsion. Such are well known to those skilled in such art. The bound styrene content can vary, for example, from about 5 to about 50 percent. In one aspect, the E-SBR may also contain acrylonitrile to form a terpolymer rubber, as E-SBAR, in amounts, for example, of about 2 to about 30 weight percent bound acrylonitrile in the terpolymer.

Emulsion polymerization prepared styrene/butadiene/acrylonitrile copolymer rubbers containing about 2 to about 40 weight percent bound acrylonitrile in the copolymer are also contemplated as diene based rubbers for use in this invention.

The solution polymerization prepared SBR (S-SBR) typically has a bound styrene content in a range of about 5 to about 50, preferably about 9 to about 36, percent. The S-SBR can be conveniently prepared, for example, by organo lithium catalyzation in the presence of an organic hydrocarbon solvent.

In one embodiment, additional cis 1,4-polybutadiene rubber (BR) may be used.

The cis 1,4-polyisoprene and cis 1,4-polyisoprene natural rubber are well known to those having skill in the rubber art.

The term “phr” as used herein, and according to conventional practice, refers to “parts by weight of a respective material per 100 parts by weight of rubber, or elastomer.”

The rubber composition may also include up to 70 phr of processing oil. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. Suitable process oils include various oils as are known in the art, including aromatic, paraffinic, naphthenic, vegetable oils, and low PCA oils, such as MES, TDAE, SRAE and heavy naphthenic oils. Suitable low PCA oils include those having a polycyclic aromatic content of less than 3 percent weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom.

The rubber composition may include from about 1 to about 200 phr of silica.

The commonly employed siliceous pigments which may be used in the rubber compound include conventional pyrogenic and precipitated siliceous pigments (silica). In one embodiment, precipitated silica is used. The conventional siliceous pigments employed in this invention are precipitated silicas such as, for example, those obtained by the acidification of a soluble silicate, e.g., sodium silicate.

Such conventional silicas might be characterized, for example, by having a BET surface area, as measured using nitrogen gas. In one embodiment, the BET surface area may be in the range of about 40 to about 600 square meters per gram. In another embodiment, the BET surface area may be in a range of about 80 to about 300 square meters per gram. The BET method of measuring surface area is described in the Journal of the American Chemical Society, Volume 60, Page 304 (1930).

The conventional silica may also be characterized by having a dibutylphthalate (DBP) absorption value in a range of about 100 to about 400, alternatively about 150 to about 300. The conventional silica might be expected to have an average ultimate particle size, for example, in the range of 0.01 to 0.05 micron as determined by the electron microscope, although the silica particles may be even smaller, or possibly larger, in size.

Various commercially available silicas may be used, such as, only for example herein, and without limitation, silicas commercially available from PPG Industries under the Hi-Sil trademark with designations 210, 243, etc; silicas available from Rhodia, with, for example, designations of Z1165MP and Z165GR and silicas available from Degussa AG with, for example, designations VN2 and VN3, etc.

Commonly employed carbon blacks can be used as a conventional filler in an amount ranging from 10 to 150 phr. In another embodiment, from 20 to 80 phr of carbon black may be used. Representative examples of such carbon blacks include N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991.

Other fillers may be used in the rubber composition including, but not limited to, particulate fillers including ultra-high molecular weight polyethylene (UHMWPE), crosslinked particulate polymer gels including but not limited to those disclosed in U.S. Pat. Nos. 6,242,534; 6,207,757; 6,133,364; 6,372,857; 5,395,891; or 6,127,488, and plasticized starch composite filler including but not limited to that disclosed in U.S. Pat. No. 5,672,639. Such other fillers may be used in an amount ranging from 1 to 30 phr.

In one embodiment the rubber composition may contain a conventional sulfur containing organosilicon compound. In one embodiment, the sulfur containing organosilicon compounds are the 3,3′-bis(trimethoxy or triethoxy silylpropyl) polysulfides. In one embodiment, the sulfur containing organosilicon compounds are 3,3′-bis(triethoxysilylpropyl) disulfide and/or 3,3′-bis(triethoxysilylpropyl) tetrasulfide.

In another embodiment, suitable sulfur containing organosilicon compounds include compounds disclosed in U.S. Pat. No. 6,608,125. In one embodiment, the sulfur containing organosilicon compounds includes 3-(octanoylthio)-1-propyltriethoxysilane, CH₃(CH₂)₆C(═O)—S—CH₂CH₂CH₂Si(OCH₂CH₃)₃, which is available commercially as NXT™ from Momentive Performance Materials.

In another embodiment, suitable sulfur containing organosilicon compounds include those disclosed in U.S. Pat. No. 6,849,754. In one embodiment, the sulfur containing organosilicon compound is Si-363 from Degussa.

The amount of the sulfur containing organosilicon compound in a rubber composition will vary depending on the level of other additives that are used. Generally speaking, the amount of the compound will range from 0.5 to 20 phr. In one embodiment, the amount will range from 1 to 10 phr.

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators and retarders and processing additives, such as oils, resins including tackifying resins and plasticizers, fillers, pigments, fatty acid, zinc oxide, waxes, antioxidants, and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. In one embodiment, the sulfur-vulcanizing agent is elemental sulfur. The sulfur-vulcanizing agent may be used in an amount ranging from 0.5 to 8 phr, alternatively with a range of from 1.5 to 6 phr. Typical amounts of tackifier resins, if used, comprise about 0.5 to about 10 phr, usually about 1 to about 5 phr. Typical amounts of processing aids comprise about 1 to about 50 phr. Typical amounts of antioxidants comprise about 1 to about 5 phr. Representative antioxidants may be, for example, diphenyl-p-phenylenediamine and others, such as, for example, those disclosed in The Vanderbilt Rubber Handbook, edited by Robert O. Babbit (Norwalk, Connecticut, R.T., Vanderbilt Company, Inc., 1978), Pages 344 through 346. Typical amounts of antiozonants comprise about 1 to 5 phr. If used, typical amounts of fatty acids, which can include stearic acid comprise about 0.5 to about 3 phr. Typical amounts of zinc oxide comprise about 2 to about 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from about 0.5 to about 4, alternatively about 0.8 to about 1.5, phr. In another embodiment, combinations of a primary and a secondary accelerator might be used with the secondary accelerator being used in smaller amounts, such as from about 0.05 to about 3 phr, in order to activate and improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. In one embodiment, the primary accelerator is a sulfenamide. If a second accelerator is used, the secondary accelerator may be a guanidine, dithiocarbamate or thiuram compound.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage, which is conventionally called the “productive” mix stage, in which the mixing typically occurs at a temperature, or ultimate temperature, lower than the mix temperature(s) of the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

The 1,4-cis polydienes, or elastomers or rubber compositions of this invention may be incorporated into various articles of manufacture, for example tires and industrial rubber products, may be prepared using such rubber compositions. Upon vulcanization, such a rubber composition may be incorporated into a pneumatic or non-pneumatic tire, belt, hose, air spring, shoe product or motor mount. In the case of a tire, the rubber composition may be incorporated in a variety of rubber tire components, such as, for example, a tread (including tread cap and/or tread base), sidewall, apex, chafer, sidewall, insert, wirecoat and/or innerliner. In one embodiment, the compound is a tread. In yet further embodiments, the composition can be used in adhesives.

A pneumatic tire of the present invention may be a race tire, passenger tire, aircraft tire, agricultural, earthmover, off-the-road, truck tire, and the like. In one embodiment, the tire is a passenger or truck tire. The tire may also be radial or bias.

This invention is illustrated by the following examples that are merely for the purpose of illustration and are not to be regarded as limiting the scope of the invention or the manner in which it can be practiced. Unless specifically indicated otherwise, parts and percentages are given by weight.

### EXPERIMENTS

### TAXI Preparation

In a 20 mL glass vial with rubber septa cap, was added a magnetic stirrer bar, 0.93 g of [dimethyl(vinyl)siloxy]bis(methyl)(vinyl)silane, and 2 mL of 1,2-epoxydodecane. The vial was purged with dry nitrogen gas for about 30 seconds and immediately closed. To the vial was added 1.35 g of disulfur dichloride (S₂Cl₂) and was allowed to stir at 70° C. for 90 minutes. Then was added 13 mL of 1,2-epoxydodecane and was allowed to stir for another 2-5 minutes. The content of the vial was approximately 17 mL of an oily homogenous mixture. By visual observation and monitoring, the mixture showed relative increase in viscosity or thickness throughout the time of the reaction in addition to showing a darker color by passing time. The mixture is ready to be used and can be added to a terminated neodymium cement or an anionic butadiene/SBR cement. Different amounts of the mixture will be taken out by a syringe and a needle and subsequently be added to the neodymium cement bottle.

### Experiment 1 (Control)

An oven-dried 16 oz glass bottle with rubber septa cap was purged with dry nitrogen. The bottle was charged with 125 g of butadiene solution in hexane (13.5% wt premix). About 65 microliter of 1 M DIBALH solution in hexane was added to the bottle in addition to 0.5 mL of 0.06 M of neodymium preformed catalyst. The bottle was tumbled for 60-75 minutes in a water bath maintained at 65° C. The polymerization was terminated with 2.5 mL stearic acid solution 3% in hexane. The bottle was tumbled for another 10-20 minutes and then 2 mL of water in addition to 2 mL of 1% solution of Irganox 1520 in isopropanol were added. The bottle was allowed to tumple for another 10-20 minutes and then was poured to a plate for drying and subsequent vacuum oven-drying. The yield of the polymer was 16.2 g (96.1%). The Mooney viscosity result (ML1+4 at 100° C.) came at 33.1 by using a Monsanto Mooney viscometer with a large rotor, a one-minute warm-up time, and a four-minute running time. As determined by gel permeation chromatography (GPC), the polymer had a number average molecular weight (Mn) of 190,000 g/mole, a weight average molecular weight (Mw) of 361,000 g/mole, and a molecular weight distribution (Mw/Mn) of 1.9. The infrared spectroscopic analysis of the polymer indicated a 1,4-cis-linkage content of >95%, and a 1,2-linkage content of <1%.

### Experiment 2

An oven-dried 16 oz glass bottle with rubber septa cap was purged with dry nitrogen. The bottle was charged with 125 g of butadiene solution in hexane (13.5% wt premix). About 65 microliter of 1 M DIBALH solution in hexane was added to the bottle in addition to 0.5 mL of 0.06 M of neodymium preformed catalyst. The bottle was tumbled for 60-75 minutes in a water bath maintained at 65° C. The polymerization was terminated with 2.5 mL stearic acid solution 3% in hexane. The bottle was tumbled for another 10-20 minutes. As discussed above the TAXI formation, 0.85 mL of that oily mixture was added to the bottle and was allowed to stir for 20-30 minutes. Then 2 mL of water in addition to 2 mL of 1% solution of Irganox 1520 in isopropanol were added. The bottle was allowed to tumble for another 10-20 minutes and then was poured to a plate for drying and subsequent vacuum oven-drying. The yield of the polymer was 16.3 g (96.8%). The Mooney viscosity result (ML1+4 at 100° C.) came at 46.1 by using a Monsanto Mooney viscometer with a large rotor, a one-minute warm-up time, and a four-minute running time. As determined by gel permeation chromatography (GPC), the polymer had a number average molecular weight (Mn) of 242,000 g/mole, a weight average molecular weight (Mw) of 823,000 g/mole, and a molecular weight distribution (Mw/Mn) of 3.41.

### Experiment 3

An oven-dried 16 oz glass bottle with rubber septa cap was purged with dry nitrogen. The bottle was charged with 125 g of butadiene solution in hexane (13.5% wt premix). About 65 microliter of 1 M DIBALH solution in hexane was added to the bottle in addition to 0.5 mL of 0.06 M of neodymium preformed catalyst. The bottle was tumbled for 60-75 minutes in a water bath maintained at 65° C. The polymerization was terminated with 2.5 mL stearic acid solution 3% in hexane. The bottle was tumbled for another 10-20 minutes. As discussed above the TAXI formation, 1.7 mL of that oily mixture was added to the bottle and was allowed to stir for 20-30 minutes. Then 2 mL of water in addition to 2 mL of 1% solution Irganox 1520 in isopropanol were added. The bottle was allowed to tumble for another 10-20 minutes and then was poured to a plate for drying and subsequent vacuum oven-drying. The yield of the polymer was 16.5 g (97.9%). The Mooney viscosity result (ML1+4 at 100° C.) came at 57.5 by using a Monsanto Mooney viscometer with a large rotor, a one-minute warm-up time, and a four-minute running time. As determined by gel permeation chromatography (GPC), the polymer had a number average molecular Weight (Mn) of 287,000 g/mole, a weight average molecular weight (Mw) of 1,001,000 g/mole, and a molecular weight distribution (Mw/Mn) of 3.49.

### Experiment 4

An oven-dried 16 oz glass bottle with rubber septa cap was purged with dry nitrogen. The bottle was charged with 125 g of butadiene solution in hexane (13.5% wt premix). About 65 microliter of 1 M DIBALH solution in hexane was added to the bottle in addition to 0.5 mL of 0.06 M of neodymium preformed catalyst. The bottle was tumbled for 60-75 minutes in a water bath maintained at 65° C. The polymerization was terminated with 2.5 mL stearic acid solution 3% in hexane. The bottle was tumbled for another 10-20 minutes. As discussed above the TAXI formation, 2.55 mL of that oily mixture was added to the bottle and was allowed to stir for 20-30 minutes. Then 2 mL of water in addition to 2 mL of 1% solution of Irganox 1520 in isopropanol were added. The bottle was allowed to tumble for another 10-20 minutes and then was poured to a plate for drying and subsequent vacuum oven-drying. The yield of the polymer was 16.6 g (98.5%). The Mooney viscosity result (ML1+4 at 100° C.) came at 73.9 by using a Monsanto Mooney viscometer with a large rotor, a one-minute warm-up time, and a four-minute running time. As determined by gel permeation chromatography (GPC), the polymer had a number average molecular weight (Mn) of 221,000 g/mole, a weight average molecular weight (Mw) of 1,884,000 g/mole, and a molecular weight distribution (Mw/Mn) of 8.51.

### Experiment 5

An oven-dried 16 oz glass bottle with rubber septa cap was purged with dry nitrogen. The bottle was charged with 125 g of butadiene solution in hexane (13.5% wt premix). About 65 microliter of 1 M DIBALH solution in hexane was added to the bottle in addition to 0.5 mL of 0.06 M of neodymium preformed catalyst. The bottle was tumbled for 60-75 minutes in a water bath maintained at 65° C. The polymerization was terminated with 2.5 mL stearic acid solution 3% in hexane. The bottle was tumbled for another 10-20 minutes. As discussed above the TAXI formation, 3.4 mL of that oily mixture was added to the bottle and was allowed to stir for 20-30 minutes. Then 2 mL of water in addition to 2 mL of 1% solution of Irganox 1520 in isopropanol were added. The bottle was allowed to tumble for another 10-20 minutes and then was poured to a plate for drying and subsequent vacuum oven-drying. The yield of the polymer was 16.6 g (98.5%). The Mooney viscosity result (ML1+4 at 100° C.) came at 82.6 by using a Monsanto Mooney viscometer with a large rotor, a one-minute warm-up time, and a four-minute running time. As determined by gel permeation chromatography (GPC), the polymer had a number average molecular weight (Mn) of 221,000 g/mole, a weight average molecular weight (Mw) of 2,456,000 g/mole, and a molecular weight distribution (Mw/Mn) of 11.11.

### Experiment 6

An oven-dried 16 oz glass bottle with rubber septa cap was purged with dry nitrogen. The bottle was charged with 125 g of butadiene solution in hexane (13.5% wt premix). About 65 microliter of 1 M DIBALH solution in hexane was added to the bottle in addition to 0.5 mL of 0.06 M of neodymium preformed catalyst. The bottle was tumbled for 60-75 minutes in a water bath maintained at 65° C. The polymerization was terminated with 2.5 mL stearic acid solution 3% in hexane. The bottle was tumbled for another 10-20 minutes. As discussed above the TAXI formation, 4.25 mL of that oily mixture was added to the bottle and was allowed to stir for 20-30 minutes. Then 2 mL of water in addition to 2 mL of 1% solution of Irganox 1520 in isopropanol were added. The bottle was allowed to tumble for another 10-20 minutes and then was poured to a plate for drying and subsequent vacuum oven-drying. The yield of the polymer was 16.7 g (99.1%). The Mooney viscosity result (ML1+4 at 100° C.) came at 82.0 by using a Monsanto Mooney viscometer with a large rotor, a one-minute warm-up time, and a four-minute running time. As determined by gel permeation chromatography (GPC), the polymer had a number average molecular weight (Mn) of 228,000 g/mole, a weight average molecular weight (Mw) of 1,466,000 g/mole, and a molecular weight distribution (Mw/Mn) of 6.44.

Variations in the present invention are possible in view of the description provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method for the synthesis of an elastomer comprising the steps of:
polymerizing conjugated diene monomer to generate a polydiene cement;
terminating the polydiene cement with a protic organic compound;
separately reacting (1) a compound containing sulfur and a halogen with (2) a silane or siloxane; and
adding a product of the reaction to the cement to generate a polydiene rubber.

2. The method of claim 1, wherein the silane comprises at least one unsaturated carbon-carbon bond.

3. The method of claim 1, wherein the siloxane comprises at least one unsaturated carbon-carbon bond.

4. The method of claim 1, wherein the compound containing sulfur and a halogen is disulfur dichloride (S₂Cl₂), sulfur dichloride, disulfur dibromide, sulfur dibromide, thionyl chloride, thionyl bromide or a combination thereof.

5. The method of claim 4, wherein the reaction between the S₂Cl₂ and silane/siloxane is performed at 0° C. to 120° C.

6. The method of claim 4, wherein the reaction between the S₂Cl₂ and silane/siloxane uses a solvent.

7. The method of claim 4, wherein the reaction between the S₂Cl₂ and silane/siloxane excludes a solvent.

8. The method of claim 1, wherein the adding of (1) and (2) is performed with agitation or stirring.

9. The method of claim 1, wherein the adding of (1) and (2) is performed without agitation or stirring.

10. The method of claims 3 and 4, wherein a mole ratio between (1) the compound containing sulfur and a halogen and (2) the silane or siloxane bearing one unsaturated carbon-carbon bond is between 4 to 1.

11. The method of claim 1, wherein the total amount of the silane/siloxane is from 0.5 mmol to 7.5 mmol per 100 grams of the polydiene cement.

12. The method of claim 1, wherein the elastomer is one of 1,4-cis polybutadiene and styrene butadiene.

13. The method of claim 1, wherein the elastomer is characterized by an increase of at least 35% in Mooney viscosity (ML 1+4 at 100° C.) compared to the Mooney viscosity of the elastomer without the addition of (1) the compound containing sulfur and a halogen and (2) the silane or siloxane.

14. The method of claim 1, wherein the elastomer is functionalized.

15. The method of claim 1, wherein the polymer is prepared by:
polymerizing conjugated diene monomer at temperatures of 25° C. to 125° C. in presence of at least one rare earth transition metal catalyst system based on neodymium carboxylate or neodymium phosphate, a saturated aliphatic or alicyclic organic hydrocarbon solvent, an alkylating agent based on aluminum, and organometallic halogen source to generate the polydiene cement.

16. The method of claim 1, wherein polymerizing the conjugated diene monomer comprises:
polymerizing a conjugated diene monomer compound in the presence of alkyl lithium and a modifier to generate the polydiene cement.

17. The method of claim 16, wherein the alkyl lithium is butyl lithium.

18. The method of claim 1, wherein polymerizing the conjugated diene monomer comprises:
polymerizing a conjugated diene monomer compound and styrene in the presence of alkyl lithium and a modifier to generate the polydiene cement.

19. A tire having a tread or carcass compound comprising at least the 1,4-cis polydiene of claim 1.
